(19) United States
(12) Patent Application Publication
(10) Pub. No.: US 2009/0103185 A1
(43) Pub. Date: Apr. 23, 2009

(54) ELECTRONIC DEVICE HAVING A LIQUID-BASED OPTICAL DEVICE AND CONTROL METHOD THEREFOR

(75) Inventors: Ivon F. Helwegen, St. Odilienberg (NL); Stein Kuiper, Vught (NL); Bernardus H.W. Hendriks, Eindhoven (NL); Robert W.J. Zijlstra, Kenley (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,619

(22) PCT Filed: Oct. 28, 2005
(86) PCT No.: PCT/IB2005/053525

§ 371 Date: May 4, 2007

(30) Foreign Application Priority Data
Nov. 10, 2004 (EP) 0424763.1

(51) Int. Cl. G02B 3/14

(52) U.S. Cl. 359/666

(57) ABSTRACT

The present invention discloses an electronic device (1) comprising an optical device (10) having a container enclosing an insulating liquid (A) and an electrically susceptible liquid (B), the insulating liquid (A) and the electrically susceptible liquid (B) being immiscible and being in contact with each other via an interface (14), at least one of the liquids (A; B) being at least partially placed in a light path through the container. The electronic device further comprises first signal generating means (34) for generating a control signal indicative of a difference between the actual position of the interface (14) and a desired position; second signal generating means (50) for generating a further control signal for adapting the position of the interface (14) in response to the control signal; and control means (40) for prohibiting the second signal generating means (50) to update the further control signal during a positional change of the interface. Consequently, it is avoided that an update of the further control signal, e.g. a driving voltage of the optical device, is based on a control signal, e.g. a focus error signal, derived from an unstable interface (14).

The present invention relates to an electronic device having optical device an optical device comprising a container enclosing a first liquid and an electrically susceptible second liquid, said liquids being immiscible and being in contact with each other via an interface, at least one of said liquids being at least partially placed in a light path through the container; and means for controlling a position of the interface.

Electronic devices including optical devices that are based on the manipulation of liquids are rapidly gaining large commercial interest, not in the least because of the lack of mechanically moving parts and the relative simplicity of the optical devices, making the optical devices cheap and durable.

Examples of such optical devices can be found in US patent application US2001/0017985, which discloses an optical device that incorporates two immiscible liquids with equal refractive indices but different transmittances, with one of the two liquids being conductive. By varying the interface between these two liquids, the amount of each of the liquids in the light path through the device is changed and a diaphragm is obtained as a result.

International patent application WO03/069380 discloses a cylindrical variable focus lens incorporating two immiscible fluids having different refractive indices, one of the fluids being conductive and the other being insulating. These fluids preferably have a comparable density to avoid a gravitational dependency of the orientation of the liquids on the orientation of the lens. The shape of the interface between the two fluids is manipulated by applying a voltage across the lens, which can be used to introduce a change in the focal point of the lens. The walls of the cylinder and one of the transparent lids of the cylinder are coated with a hydrophobic coating to ensure that at least in a switched off state the contact area between the conductive fluid, which typically is a polar liquid, and said walls is minimized to facilitate a variable focus lens with a large optical power range.

However, the replacement of traditional optical devices, e.g., glass lens systems, with these novel liquid-based optical devices is not without problems. For instance, a change in position of the interface of the optical device in order to vary its optical function such as a variable focus function tends to cause a temporary disruption to the interface shape, such as an oscillation running over the interface surface.

It is recognized that this causes a problem for electronic devices that utilize an output of the optical device in a feedback mechanism for controlling the optical function of the optical device, e.g., an autofocus algorithm, because traditional feedback mechanisms in such electronic devices rely on the shape of the optical elements being a constant. Typically, in such a mechanism, a driver circuit will indicate when a predefined voltage is reached, after which a new error signal can be calculated. This can lead to the unwanted situation where a disturbance of the interface shape of the liquid-based optical device is erroneously interpreted by the feedback mechanism as a positional error. Such interpretation errors can significantly delay the convergence of the implemented algorithm, and should therefore be avoided.

The present invention seeks to provide an electronic device as described in the opening paragraph and a control method for such a device that facilitates robust feedback-based control of the optical function of an incorporated liquid-based optical device.

According to an aspect of the invention, there is provided an electronic device comprising an optical device comprising a container enclosing a first liquid and an electrically susceptible second liquid, said liquids being immiscible and being in contact with each other via an interface, at least one of said liquids being at least partially placed in a light path through the container; first signal generating means for generating a control signal indicative of a deviation of the interface from an intended position; second signal generating means for generating a further control signal for adapting the position of the interface in response to the control signal; and control means for prohibiting the second signal generating means to receive an update of the control signal during a positional change of the interface.

In the electronic device of the present invention, the control signal indicative of a deviation of the actual interface position from a desired position may be an error signal indicating a deviation from an intended focus in case of the optical device being a lens or a deviation from an intended light intensity in case of the optical device being a diaphragm, is only fed to the control means for generating a further control signal for controlling the position of the interface in response to the control signal upon the control signal reaches a value reflecting a stable configuration of the interface. To this end, the electronic device comprises control means, which may be coupled between the first signal generating means and the second signal generating means for prohibiting the second signal generating means to update the further control signal during a positional transition of the interface, which ensures that the further control signal, e.g., a driving voltage, is only updated responsive to a control signal that corresponds to a stable interface, thus avoiding erroneous positional transitions of the interface.

In an embodiment, the control means are arranged to release an update enable signal after a predefined time period, the time period being at least as long as a predetermined duration of a positional change of the interface. This ensures that the second signal generating means are only responsive to the control signal after a time period long enough for the interface to settle after a positional change. This time period may be predefined based on empirical data of the time-dependent switching behaviour of the optical device. The delay circuitry may be responsive to the second signal generating means, which may be used to initiate the time period upon the second signal generating means signalling that the further control signal has reached its intended value.

Alternatively, the time interval may be dynamically determined. To this end, the control means comprise a control signal differentiating circuit, said differentiating circuit being arranged to release an update enabling signal upon the control signal differentiation meeting a predefined condition. This has the advantage that the time interval between subsequent generations of the further control signal is minimized, which improves the convergence speed of the optical function of the optical device. An additional advantage is that ageing effects of the optical device that affect the switching speed are automatically compensated for.

In an embodiment, the control signal differentiating circuit comprises a first memory element for storing an initial value of the control signal; a second memory element for storing a subsequent value of the control signal, and a subtractor for subtracting the initial value from the subsequent value, the predefined condition comprising a threshold for the allowable difference between the initial value and the subsequent value. This has the advantage that a very simple implementation requiring little hardware is achieved.

The further control means may further comprise a counter for registering subsequent occurrences of the control signal differentiation meeting a further predefined condition. This way, a distinction can be made by a control signal indicating an acceptable error margin that relates to an interface in oscillation with the interface having the correct geometry at the time of the differentiation and an interface having a correct and stable geometry.

The control signal differentiating circuit may be responsive to the second signal generating means, because the evaluation of the control signal is only relevant after the further control signal has reached its intended value, which is when the influence of a disturbance of the interface shape on the value of the control signal should be avoided.

Alternatively, the control means comprise an electrode structure, at least a part of the electrode structure forming a capacitor with the electrically susceptible liquid by being separated from the electrically susceptible second liquid by a dielectric layer, the control means being arranged to prohibit the second signal generating means to receive an update of the control signal during a positional change of the interface based on an evaluation of the magnitude of the capacitance of the capacitor. In this embodiment, the control means operate independent of the control signal.

There are several ways to ensure that the second signal generating means are not responding to the control signal during an instability of the interface. The second signal generating means typically comprise of some logic function for decoding the control signal and a voltage generator, which may be an AC or DC voltage generator responsive to the logic function. The logic function may be put in dormant mode during a transition of the interface, during which the control signal is not interpreted. The logic function is activated upon receipt of the enable signal.

Alternatively, the electronic device may comprise a switch in a signal path between the first signal generating means and the second signal generating means, said switch being responsive to the enable signal. This has the advantage that the second signal generating means can be decoupled from the first signal generating means without having to partially deactivate the second signal generating means.

In an embodiment, the first signal generating means comprise an image sensor for registering an image captured by the optical device, and a processor coupled to the image sensor, the processor being arranged to generate the control signal based on an output of the image sensor, typically by evaluating a characteristic of the image captured by the image sensor. According to another aspect of the invention, there is provided a method for controlling an electronic device having an optical device comprising a container enclosing a first liquid and an electrically susceptible second liquid, said liquids being immiscible and being in contact with each other via an interface, at least one of said liquids being at least partially placed in a light path through the container; the method comprising generating a control signal indicative of a difference between the actual position of the interface and a desired position; generating a further control signal for adapting the position of the interface in response to the control signal; and prohibiting the second signal generating means to update the further control signal during a positional change of the interface. This has the advantage that updates of the further control signal based on an erroneous control signal are avoided.

The invention is described in more detail and by way of non-limiting examples with reference to the accompanying drawings, wherein:

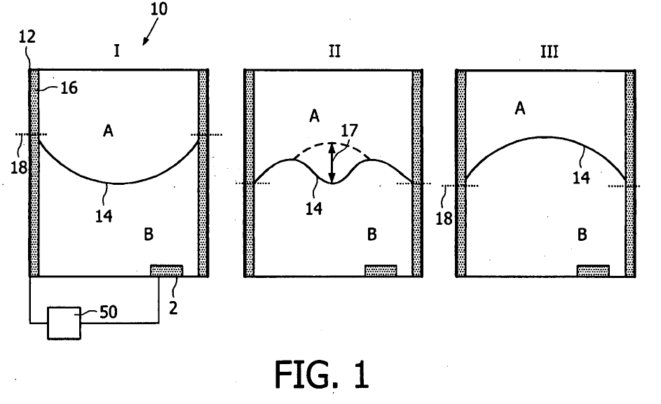

FIG. 1 schematically depicts the switching behaviour of a liquid based optical device;

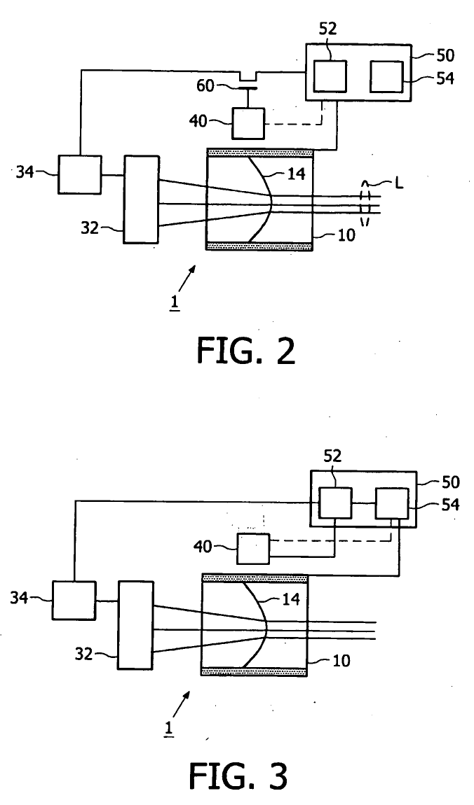

FIG. 2 shows an embodiment of the electronic device of the present invention;

FIG. 3 shows another embodiment of the electronic device of the present invention;

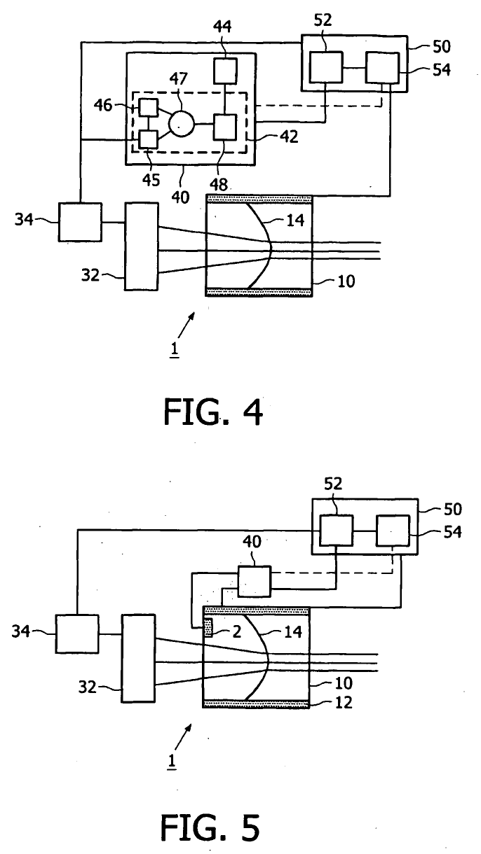

FIG. 4 shows another embodiment of the electronic device of the present invention; and

FIG. 5 shows a further embodiment of the electronic device of the present invention.

It should be understood that the Figures are merely schematic and are not drawn to scale. It should also be understood that the same reference numerals are used throughout the Figures to indicate the same or similar parts.

FIG. 1 shows an optical device 10, which may be a variable focus lens as disclosed in. International Patent application WO 03/069380. The optical device 10 comprises a first liquid A and a second, electrically susceptible, liquid B housed in a cylindrical chamber. The liquids are immiscible, have different refractive indices and preferably have the same density to avoid orientation-dependent gravitational effects on the orientation of the liquids including the interface 14 between the liquids. The inner walls of the cylindrical chamber may be covered by a hydrophobic coating such as AF1600™ from the DuPont company, which may be combined with for instance a parylene stack to create an insulating dielectric layer 16 between a wall electrode 12 and the second liquid B. A voltage source 50 is used to apply a voltage across the wall electrode 12 and a further electrode 2.

During operation, a change in voltage applied by voltage source 50 causes a change in the wettability of the inner wall of the container, which causes the interface to change its shape from an initial contact position 18 to a final contact position 18′, e.g. from a concave to a convex shape, as shown in position I and III respectively. In case of the optical device 10 being a variable focus lens, this will change the focal point of the lens. Typically, the voltage source 50 signals an image capturing device such as a sensor coupled to a signal processor (not shown) that it has completed the voltage transformation, which is a trigger for the image capturing device to capture the image that is generated by the optical device 10. However, with liquid based optical devices such as optical device 10, there is no guaranteed temporal correlation between the voltage source 50 completing the voltage transformation and the optical device 10 reaching the corresponding final position. A positional change of the interface 14 tends to introduce a damped oscillation on the interface 14, as indicated by arrow 17 in the middle part (II) of FIG. 1, which still is present when the voltage source 50 has completed its voltage transformation. If an image capturing device is allowed to capture the image generated by the optical device 10 while this oscillation is still present, the image capturing device will capture a distorted image, which can lead to the erroneous generation of a control signal such as an error signal.

FIG. 2 shows a first embodiment of an electronic device of the present invention in which the influence of such an erroneous signal on the driving of the optical device is avoided. The electronic device 1 comprises an optical device 10 as previously described. A sensor 32 is placed behind the optical device 10 to capture the light from light path L through the optical device 10.

The sensor 32 produces an output signal, which may be a RGB, CMY or CMYK signal, which is further processed by processor 34. Processor 34 is typically arranged to evaluate the image generated by sensor 32, and to generate a control signal that indicates a deviation of the generated image from an intended image. Since the deviation from the intended image, e.g. a focussing deviation, is related to a difference between the actual position and a desired position of the interface 14, the control signal can be used to alter the position of the interface 14. The control signal is forwarded to the voltage source 50, which may include logic 52 for evaluating the control signal and voltage generator 54 responsive to logic 52. The voltage generated by voltage generator 54 is an example of a further control signal for adapting the position of the interface 14 in response to the control signal from the processor 34.

As previously explained, the present invention is based on the realization that it should be avoided that the update of the further control signal is based on a control signal derived from an evaluation of an image captured by the sensor 32 from a disturbed interface 14. To this end, the electronic device 1 further comprises a control circuit 40 and a switch 60 in the signal path from the processor 34 to the voltage source 50. The switch 60 is responsive to control circuit 40. The control circuit 40 is configured to, upon notification that a position of the interface 14 is being updated, disable the switch 60 for a predetermined period of time. This notification may be provided by the voltage source 50, as indicated by the dashed line from voltage source 50 to the controls circuit 40. Typically, this period of time is chosen to be long enough to allow the interface 14 to assume a stable position again. This prevents the voltage source 50 to update the further control signal, i.e. the voltage across electrode pair 2 and 12 based on a control signal from the processor 34 that is derived from an unstable interface 14. The voltage source 50 is triggered to sample the control signal again upon sensing the enabling of the switch 60 or by an enable signal from the control circuit 40 that is generated after completion of the time interval. In the latter case, the switch 60 may be omitted, because the voltage source 50 is only sensitive to the control signal upon activation by the enable signal generated by the control circuit 40.

The predetermined time period embedded in the control circuit 40 may be a single value, based on a measured worst case switching time for the interface 14, e.g. from an extreme convex to an extreme concave shape. However, this may be unwanted in applications where the time delay between subsequent switching steps of the interface 14 should be kept as small as possible. For those applications, the control circuit 40 may comprise a look up table (LUT) in which delay times as a function of the applied voltage are stored, in which case the control circuit 40 selects the appropriate time delay based on the applied voltage, the previously applied voltage or the difference between these two voltages. The control circuit 40 may also be responsive to a temperature sensor (not shown), to allow for the correction of predetermined temperature effects on the switching time of the interface 14.

FIG. 3 shows another embodiment of the electronic device 1 of the present invention. Compared to FIG. 2, the switch 60 has been omitted and the logic 52 in voltage source 50 has been made responsive to the control circuit 40. Logic 52 is configured to translate the control signal received from processor 34 into a voltage generation command for voltage generator 54. As soon as the control circuit 40 is notified that a position of the interface 14 is being changed, e.g. by detecting a change in the output voltage of voltage generator 54 or by a notification signal from voltage source 50, the control circuit disables the logic 52, to prevent updating of the voltage generation command during the positional change of the interface 14. Logic 52 may receive the control signal in a digital form, and may comprise a register (not shown) responsive to the enable signal from the control circuit 40 for storing the control signal. Upon completion of the predetermined time interval, the control circuit 40 releases the update enable signal allowing logic 52 to capture an updated value of the control signal in its register. Logic 52 may also receive the control signal in an analog form, in which case the value can be stored on for instance a capacitor (not shown), which is enabled to sample a new value of the control signal upon release of the update enable signal by control circuit 40.

FIG. 4 shows another embodiment of the electronic device 1 of the present invention, in which the time interval is dynamically determined by the control circuit 40. In this embodiment, the control circuit 40 is made responsive to the processor 34. The control circuit 40 comprises a differentiating circuit 42, for differentiating the temporal behaviour of the control signal. The differentiating circuit 42 is arranged to release an update enable signal when the control signal differentiation meets a predefined condition. Typically, this predefined condition is a threshold of a maximum allowed value for differentiation. Preferably, the predefined condition is defined as a number of subsequent occasions of the differentiation result falling below the predefined threshold, to ensure that the interface 14 has reached a stable geometry. For this purpose, a counter 44 may be added to count the number of subsequent occasions of a differentiation result falling below the required threshold. Each occurrence of the differentiation result falling below the required threshold can be seen as a further predefined condition being met, with the predefined condition being defined as a number of subsequent occurrences of the further predefined condition. The generated update enable signal may again be used to control a switch 60 as shown in FIG. 2, or logic 52 as shown in FIG. 3, and so on.

The differentiating circuit 42 may be implemented according to any known implementation of such functionality. In an embodiment, the differentiating circuit comprises a first memory element 45 for storing a recent value of the control signal, a second memory element 46 for storing a previous value of the control signal, a subtractor 47 coupled to both memory elements 45 and 46 for subtracting the value stored in the second memory element 46 from the value stored in the first memory element 45 and a comparator 48 coupled to the output of the subtractor 47 for comparing the output of the subtractor 47 with a predefined condition or predefined further condition, as previously explained. First and second memory element 45 and 46 may form a two-stage multibit shift register, with the data from the first memory element 45 being shifted to the second memory element 46 upon receipt of an updated value of the control signal.

Optionally, the comparator 48 is coupled to the counter 44 to signal the counter if the predefined further condition is met, with the counter 44 being configured to generate the update enable signal upon reaching a predefined value, i.e. the predefined condition. After the generation of the update enable signal, the counter will reset itself to zero. If the comparator 48 detects a non-compliance with the predefined further condition, the counter 44 will also be reset to zero, without the update enable signal being generated. Alternatively, a larger number memory elements are included in the control circuit 40 for storing more values of the control signal. This obviates the need to have a counter 44 present, because evaluation of more than two values of the control signal can also provide the ensurance that the interface 14 has reached a stable geometry.

The evaluation of the dynamic behaviour of the interface 14 by the control circuit 40 is not restricted to the evaluation of the control signal generated by the processor 34. FIG. 5 shows an alternative embodiment of the electronic device 1 of the present invention. In this embodiment, the control circuit 40 is coupled to the wall electrode 12 and the further electrode 2 to monitor the temporal behaviour of the capacitance of the capacitor that is formed by the wall electrode 12, the dielectric layer 16 and the contact area of the electrically susceptible liquid B with the dielectric layer 16. Due to the fact that this contact area changes during a transition or an oscillation of the interface 14, a fluctuation in the capacitance of this capacitor of the optical device 10 is an indication of the interface 14 being unstable. Consequently, the control circuit 40 is arranged to release the update enable signal upon the temporal behaviour of the capacitance meeting a predefined condition, similar to the predefined condition described previously. The temporal behaviour of the capacitance may be evaluated in the same way as shown for the evaluation of the control signal in FIG. 4 and described in the detailed description thereof.

At this point, it is emphasized that the prohibition of an update of the further control signal is intended, to include switching the second signal generating means to a dormant state during the positional change of the interface 14. Also, the further control signal does not have to be a constant signal; it may for instance be a variable voltage waveform having a predefined shape, the waveform being initiated in response to the control signal.

It will be obvious to the skilled person that the implementation of the method of the present invention is not restricted to the aforementioned embodiments; various alternatives of the embodiments shown in FIG. 2-5 can be easily derived. For instance, rather than prohibiting logic 52 from receiving an updated control signal, the processor 34 can be made responsive to the control logic 40 to prevent the output of the updated control signal. Alternatively, the control circuit 40 may provide the processor 34 with the update enable signal and the voltage generator 54 with a delayed update enable signal, the delay being based on the processing time of the control signal from the processor 34 by logic 52. In this embodiment, the voltage generator 54 may comprise a data storage element responsive to the delayed update enable signal for capturing the output of logic 52. Also, control circuit 40 can be integrated in one of the other functional blocks of the electronic device 1, such as the processor 34, to which it can be added in hardware or in software. It will also be obvious that the present invention is not restricted to electronic devices comprising a liquid based variable focus lens, but that the invention can also used in electronic devices comprising another liquid-based optical device such as a liquid-based zoom lens, a liquid based shutter or a liquid based diaphragm such as disclosed in US patent application US2001/0017985, or in electronic devices comprising combinations of such liquid-based optical devices.

At this point, it is emphasized that in the context of the present invention, the phrase an electrically susceptible liquid is intended to include conductive liquids, polar liquids and polarizable liquids. Furthermore, it is emphasized that although in this application the means for manipulating the position of the interface 14 are depicted as an electrode arrangement for controlling the shape of the interface 14 by means of a voltage, other means for manipulating the position of the interface 14 are equally acceptable, such as manipulation by means of a magnetic field, in which case the electrically susceptible fluid comprises a ferrofluid. In the context of the present invention, the phrase electrically susceptible liquid is intended to include liquids responsive to a magnetic field.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. An electronic device (1) comprising:
an optical device (10) comprising a container enclosing a first liquid (A) and an electrically susceptible second liquid (B), said liquids (A; B) being immiscible and being in contact with each other via an interface (14), at least one of said liquids (A; B) being at least partially placed in a light path through the container;
first signal generating means (34) for generating a control signal indicative of a difference between the actual position of the interface (14) and a desired position;
second signal generating means (50) for generating a further control signal for adapting the position of the interface (14) in response to the control signal; and
control means (40) for prohibiting the second signal generating means (50) to update the further control signal during a positional change of the interface (14).

2. An electronic device (1) as claimed in claim 1 wherein the control means (40) are arranged to release an update enable signal after a predefined time period, the time period being at least as long as a predetermined duration of a positional change of the interface (14).

3. An electronic device (1) as claimed in claim 1, wherein the control means (40) are responsive to the second signal generating means (50).

4. An electronic device (1) as claimed in claim 1, wherein the control means comprise a differentiating circuit (42) for differentiating the control signal, said differentiating circuit (42) being arranged to release an update enable signal upon the control signal differentiation meeting a predefined condition.

5. An electronic device (1) as claimed in claim 4, wherein the differentiating circuit (42) comprises a first memory element (45) for storing an initial value of the control signal; a second memory element (46) for storing a subsequent value of the control signal, and a subtractor (47) for subtracting the initial value from the subsequent value, the predefined condition comprising a threshold for the allowable difference between the initial value and the subsequent value.

6. An electronic device (1) as claimed in claim 4, wherein the control means (40) further comprise a counter (44) for registering subsequent occurrences of the control signal differentiation falling below a further predefined condition.

7. An electronic device (1) as claimed in claim 4, wherein the differentiating circuit (42) is responsive to the second signal generating means (50).

8. An electronic device (1) as claimed in claim 2, further comprising a switch (60) in a signal path between the first signal generating means (34) and the second signal generating means (50), said switch (60) being responsive to the update enable signal.

9. An electronic device (1) as claimed in claim 1, wherein the first signal generating means (32, 34) comprise:
an image sensor (32) for registering an image captured by the optical device (10) and;
a processor (34) coupled to the image sensor (32), the processor (34) being arranged to generate the control signal based on an output of the image sensor (32).

10. An electronic device (1) as claimed in claim 1, wherein the control means (40) comprise an electrode structure (2; 12), at least a part of the electrode structure (12) forming a capacitor with the electrically susceptible liquid (B) by being separated from the electrically susceptible second liquid (B) by a dielectric layer (16), the control means (40) being arranged to prohibit the second signal generating means (50) to receive an update of the control signal during a positional change of the interface (14) based on an evaluation of the magnitude of the capacitance of the capacitor.

11. An electronic device as claimed in claim 1, wherein the electronic device is a mobile communication device.

12. An electronic device as claimed in claim 10, wherein the first signal generating means (34) is responsive to the control means (40).

13. A method for controlling an electronic device having an optical device (10) comprising a container enclosing a first liquid (A) and an electrically susceptible second liquid (B), said liquids (A; B) being immiscible and being in contact with each other via an interface (14), at least one of said liquids (A; B) being at least partially placed in a light path through the container;
the method comprising:
generating a control signal indicative of a difference between the actual position of the interface (14) and a desired position;
generating a further control signal for adapting the position of the interface (14) in response to the control signal; and
prohibiting the second signal generating means (50) to update the further control signal during a positional change of the interface (14).
